(19) United States
(12) Patent Application Publication
(10) Pub. No.: US 2010/0159907 A1
(43) Pub. Date: Jun. 24, 2010

(54) DYNAMIC CONFIGURABLE TRANSACTION SYSTEM

(75) Inventors: Pierre Farley, Ste-Marie-Salome (CA); Alain Bouchard, Rosemere (CA); Marcel Vienneau, Montreal (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: FIDELISOFT INC., Montreal, CA (US)

(21) Appl. No.: 12/338,938

(22) Filed: Dec. 18, 2008

(51) Int. Cl. H04M 3/00; G06Q 20/00

(52) U.S. Cl. 455/418; 705/35; 705/18; 705/17

(57) ABSTRACT

The present invention relates to the field of electronic transactions and more particularly concerns a dynamic configurable transaction system capable of dynamically configuring a transaction terminal and dynamically processing a transactional operation, as well as to a method associated thereto. There is provided a dynamic configurable transaction system enabling a user to complete a transactional operation through a central server. The system comprises a transaction terminal in communication with the central server via a system network and a server application at the central server. The transaction terminal includes a user interface allowing to exchange input and output information related to the transactional operation with the user and a terminal application in communication with the user interface, the terminal application comprising updatable configuration parameters and a transaction module for dynamically building a transaction flow related to the transactional operation based on the input information received via the user interface and on the updatable configuration parameters. The server application comprises a configuration update module for preparing updated configuration parameters and transmitting the updated configuration parameters to the transaction terminal.

### FIELD OF THE INVENTION

The present invention relates to the field of electronic transactions and more particularly concerns a dynamic configurable transaction system capable of dynamically configuring a transaction terminal and dynamically processing a transactional operation, as well as to a method associated thereto.

### BACKGROUND OF THE INVENTION

An electronic transaction system typically consists of a plurality of transaction terminals which are linked via a system network to a plurality of authorization hosts. A transaction terminal is generally located at a merchant's site, such as that of a retail store, service provider, and/or the like for allowing a merchant's customer to complete an electronic transactional operation. An authorization host may be a bank, a loyalty card issuer or any entity which can authorize a transactional operation with an account. In conventional transaction systems, a transaction terminal prepares a transaction request message which is transmitted to a central server. The central server then converts the transaction request message and transmits the converted message to one or more corresponding authorization host(s) such that it can be read by the authorization host(s). The authorization host receives the transaction request message, which is validated and processed, and returns a transaction confirmation message to the central server. The central server then converts the transaction confirmation message into a format compatible with the transaction terminal. Typically, such a transaction terminal contains a software which executes a sequence of instructions. When the software needs to be replaced, upgraded and/or customized, a technician is required on site to upgrade or change the software at the merchant's location.

Typically, an owner of a network of transaction terminals deployed at various merchant's sites must therefore perform this upgrade or change at each of the respective locations of the concerned transaction terminals. Such an approach proves to be lengthy, complex and costly, requires trained resources, presents a risk of inconsistency between transaction terminals, and presents security issues at installation. As a result, authorization hosts will often resist or delay upgrades to their transaction terminals or the implementation of new features or functionalities to avoid the difficulties involved in this process.

Configurable transaction terminal systems are disclosed in U.S. Pat. No. 7,086,584 issued to Stoutenburg et al. on Aug. 8, 2006, in U.S. Pat. No. 6,311,165 issued to Coutts et al. on Oct. 30, 2001, and in US patent application publication No. 2003/0101145 published in the name of Fang et al. on May 29, 2003.

The Fang et al. published patent application discloses a system allowing the transfer of information for programming a card terminal with configuration options. A merchant can log onto a system server and select programming options from a provided list. The central server formats the information into a file downloaded to the terminal which reprograms itself according to this information.

The Stoutenburg et al. patent discloses a configurable point-of-sale device which communicates with a transaction system allowing a reconfiguration file to be automatically sent to the point-of-sale device. Thus, a set of instructions are loaded into the memory of the point-of-sale device, such instructions being executable by the point-of-sale device to facilitate access to the transaction system.

The Coutts et al. patent discloses an updatable transaction processing system wherein modules or peripheral devices adapted to function as constituents of a transaction terminal, are provided with operating or application software which may be independently introduced or updated via the server at start-up, at selected maintenance intervals or dynamically at the time of transaction. The software may be in the form of downloaded bite codes or applets, such as JAVA® program code, JAVA® executable using web browser, virtual machine or compiler functioning incorporated within the module.

These teachings however suffer from drawbacks. For example, a modified software may require to be recompiled, causing the reconfiguration to be lengthy, complex and induce delays in the operation of the transaction system. Furthermore, a modification of a transaction terminal at the software level presents risks, such as the possibility of uncovering bugs in the software at the time of installation.

Thus, in light of the aforementioned, there is a need for an improved configurable transaction system which, by virtue of its design and components, would be able to overcome some of the above-discussed prior art concerns.

### SUMMARY OF THE INVENTION

The object of the present invention is to provide a system which, by virtue of its design and components, satisfies some of the above-mentioned needs and is thus an improvement over other related configurable transaction systems and/or methods known in the prior art.

In accordance with the present invention, the above-mentioned object is achieved, as will be easily understood, by a dynamic configurable transaction system enabling a user to complete a transactional operation through a central server, the system including a transaction terminal in communication with the central server via a system network, the transaction terminal including a user interface allowing to exchange input and output information related to the transactional operation with the user, and a terminal application in communication with the user interface, the terminal application including updatable configuration parameters and a transaction module for dynamically building a transaction flow related to the transactional operation based on the input information received via the user interface and on the updatable configuration parameters, the dynamic configurable transaction system further including a server application at the central server, the server application including a configuration update module for preparing updated configuration parameters and transmitting said updated configuration parameters to the transaction terminal.

According to another aspect of the present invention, there is provided a terminal application included in the transaction terminal of the above-mentioned dynamic configurable transaction system.

According to another aspect of the present invention, there is provided a method for operating the above-mentioned dynamic configurable transaction system and/or terminal application.

According to another aspect of the present invention, there is provided a method for servicing the above-mentioned dynamic configurable transaction system and/or terminal application.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a functional block diagram of the dynamic configurable transaction system according to a preferred embodiment of the present invention.

FIGS. 2a to 2d are perspective views of transaction terminals according to various embodiment of the present invention.

FIG. 3 is a diagram representing sections of a writable configuration file according to a preferred embodiment of the present invention.

FIG. 4 is a diagram representing the content of a writable label file according to a preferred embodiment of the present invention.

FIG. 5 is a diagram representing a dynamic configurable transaction system according to a preferred embodiment of the present invention.

FIG. 6 is a sequence diagram representing the operation of a dynamic configurable transaction system, according to a preferred embodiment of the present invention.

FIG. 7 is a sequence diagram representing the operational steps for updating updatable configuration parameters according to a preferred embodiment of the present invention.

FIG. 8 is a flowchart representing the operation of a terminal application according to a preferred embodiment of the present invention.

FIG. 9 is a diagram representing a sequence of screens displayed on the transaction terminal according to a preferred embodiment of the present invention.

FIG. 10a is a diagram representing the content of a writable configuration file according to an exemplary embodiment of the present invention, the diagram showing the first of three parts of the writable configuration file.

FIG. 10b is a diagram showing the second of three parts of the writable configuration file shown in FIG. 10a.

FIG. 10c is a diagram showing the third of three parts of the writable configuration file shown in FIG. 10a.

FIG. 11 is a diagram representing the content of a writable label file according to an exemplary embodiment of the present invention.

### DETAILED DESCRIPTION OF PREFERRED EMBODIMENTS OF THE INVENTION

In the following description, the same numerical references refer to similar elements. The embodiments, configurations, and/or components shown in the figures or described in the present description are preferred embodiments only, given for exemplification purposes only.

Although the preferred embodiment of the present invention as illustrated in the accompanying drawings comprises components such as a writable configuration file, a writable label file, a card reader, a keypad, etc., and although the preferred embodiment of the dynamic configurable transaction system and corresponding elements thereof consists of certain configurations as explained and illustrated herein, not all of these components and configurations are essential to the invention and thus should not be taken in their restrictive sense, i.e. should not be taken as to limit the scope of the present invention. It is to be understood, as also apparent to a person skilled in the art, that other suitable components and cooperations therein between, as well as other suitable configurations may be used for the dynamic configurable transaction system according to the present invention, as will be briefly explained herein and as can be easily inferred herefrom, by a person skilled in the art, without departing from the scope of the invention.

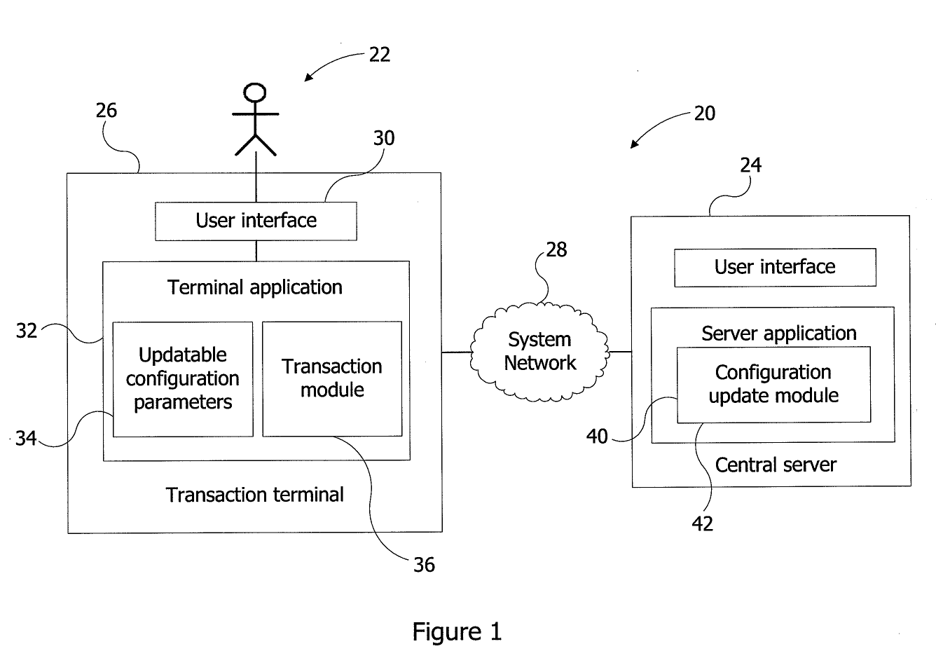

With reference to FIG. 1, there is shown a dynamic configurable transaction system according to an embodiment of the present invention, including a dynamically configurable transaction terminal application enabled to dynamically process a transactional operation based on updatable configuration parameters, typically for an electronic transaction such as a purchase, a reimbursement and/or any monetary or non monetary transaction at a retail store, a service provider, or any other merchant site. Preferably, the dynamic configurable transaction system 20 enables a user 22 to complete a transactional operation through a central server 24, and includes a transaction terminal 26 in communication with the central server 24 via a system network 28, the transaction terminal 26 including a user interface 30 allowing to exchange input and output information related to the transactional operation with the user 22, and a terminal application 32 in communication with the user interface 30, the terminal application 32 including updatable configuration parameters 34 and a transaction module 36 for dynamically building a transaction flow related to the transactional operation based on the input information received via the user interface 30 and on the updatable configuration parameters 34, and the dynamic configurable transaction system 20 further includes a server application 40 at the central server 24, the server application 40 including a configuration update module 42 for preparing updated configuration parameters 44 and transmitting said updated configuration parameters 44 to the transaction terminal 26.

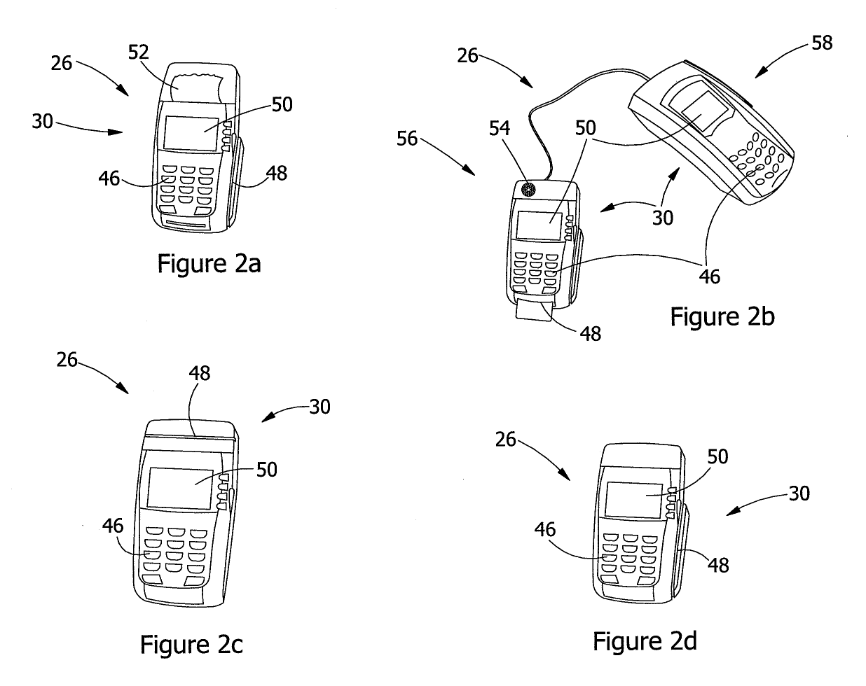

Referring now to FIG. 2a to 2d of the drawings, the transaction terminal 26 may be a handheld device, according to a preferred embodiment of the present invention. The user interface 30 of the transaction terminal 26 may include a peripheral device or module, networked with a Point-of-Sale equipment, such as a cash register, a computer, etc. Alternatively, the transaction terminal 26 may be integrated with the Point-of-Sale equipment or may stand alone and operate independently of the Point-of-Sale equipment, as can be easily understood by a person skilled in the art.

The user interface 30 of the transaction terminal 26 preferably includes a keypad 46 to allow the user 22 to enter input information. The transactional operation is preferably completed by use of an account card which is linked to an account, for example, a credit card, a bank card, a loyalty point card or any card linked to a transaction account. The account card may have the form of a smart card, a chip card, an. integrated circuit card, a magnetic stripe card or another type of electronic payment tool. Thus, the transaction terminal 26 preferably includes a card reader 48 enabled to receive and read such an account card. The input information may include card information which is entered via the card reader 48 of the user interface 30. The keypad 46 may allow the user to enter input information such as a selection from a menu, a PIN number, an amount, etc. The user interface 30 may include other data entry means, for example a microphone, a scanner, an RFID transceiver, as apparent to a person skilled in the art.

Additionally or alternatively to the elements described above, the user interface 30 may include a display screen 50 for visually communicating output information to the user 22, a printer 52 for producing a paper document containing output information, a speaker 54 for providing output information in the form of sound, and/or other means for providing output information to the user 22. The printer 52 may be enabled to print a receipt at the conclusion of a transactional operation. The speaker 54 may allow a blind or illiterate user, for example, to interact with the dynamic configurable transaction system 20 according to a preferred embodiment of the present invention.

It will be understood by one skilled in the art that the word “user” is used herein to define any person or system interacting with the user interface 30 in the course of a transaction. In practice the user may be a merchant clerk, a customer present or remote from the POS, or any other appropriate person. Indeed, in a typical transaction taking place at a POS, both the merchant clerk and the customer may be involved in inputting information in the transaction terminal and will therefore collectively define the “user” understood herein.

Referring more particularly to FIG. 2b, the user interface 30 of the transaction terminal 26 may include a pinpad 56 in communication with a main unit 58 of the transaction terminal 26. The pinpad 56 generally provides a user interface 30 for the card holder while the main unit 58 of the transaction terminal 26 provides a user interface 30 for the merchant clerk. Preferably, the pinpad 56 includes a display screen 50, a card reader 48 and a keypad 46. The pinpad 56 may be connected to the main unit 58 of the transaction terminal 26 or a cash register system via a cable, a wireless communication protocol and/or other communication means.

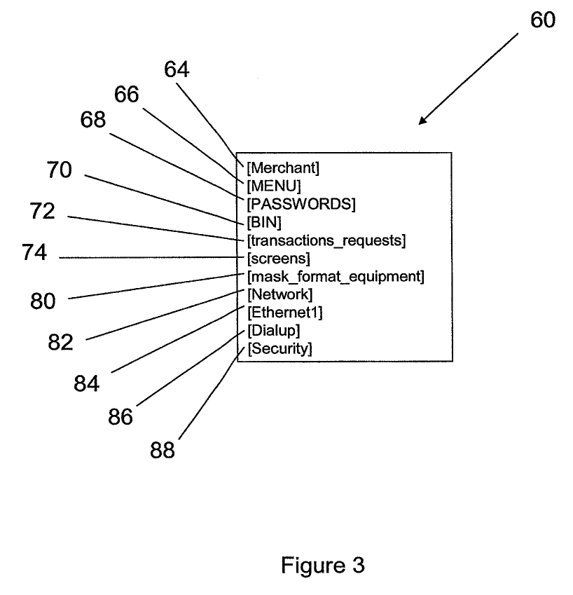

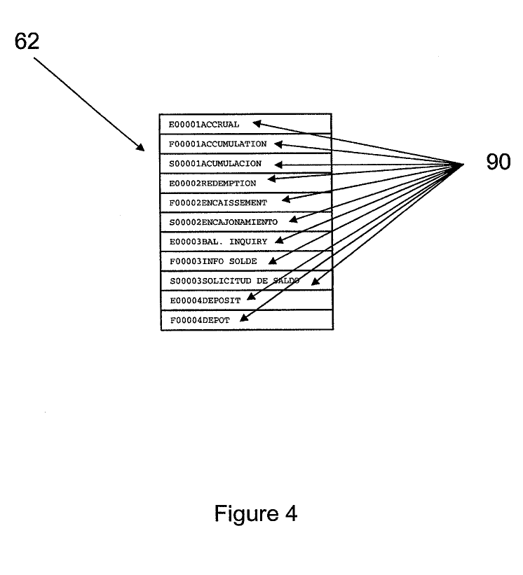

Referring now to FIGS. 3 and 4, the updatable configuration parameters 34 is preferably contained in a writable configuration file 60 and a writable label file 62. The writable configuration file 60 preferably includes categories of data such as merchant customization data, menu display screen data, password data, card type data, card range data, display screen sequence data, hardware specification data, network data and security data. The writable configuration file 60 is preferably separated in sections as illustrated in FIG. 3, each section being associated to a category of data.

Preferably, merchant customization data is associated to a ‘Merchant’ section 64 of the writable configuration file 60 and defines updatable configuration parameters 34 related to a particular merchant. The merchant customization data may include information appearing on a printed receipt, format of a printed receipt, languages supported by the transaction terminal 26, tax calculation information, personalized message, etc. According to a preferred embodiment of the present invention, the merchant customization data may include parameters as exemplified in TABLE 1.

TABLE 1

| [Merchant] | Description |
|---|---|
| WelcomeTitle1 | Merchant information used when receipt printed while offline |
| | (If online, information is provided by the host) |
| WelcomeTitle2 | Merchant information used when receipt printed while offline |
| | (If online, information is provided by the host) |
| WelcomeTitle3 | Merchant information used when receipt printed while offline |
| | (If online, information is provided by the host) |
| HeaderLine1 | Merchant information used when receipt printed while offline |
| | (If online, information is provided by the host) |
| HeaderLine2 | Merchant information used when receipt printed while offline |
| | (If online, information is provided by the host) |
| HeaderLine3 | Merchant information used when receipt printed while offline |
| | (If online, information is provided by the host) |
| Name | Merchant information used when receipt printed while offline |
| | (If online, information is provided by the host) |
| Address | Merchant information used when receipt printed while offline |
| | (If online, information is provided by the host) |
| City | Merchant information used when receipt printed while offline |
| | (If online, information is provided by the host) |
| Phone | Merchant information used when receipt printed while offline |
| | (If online, information is provided by the host) |
| Language | Language of the terminal used to select the correct label |
| FKeyEquiv | Function key replacement |
| DateUpdate | Allows the Host to update the terminal's data/time |
| SilentInit | Allows the initialization of the terminal transparently from the |
| | user |
| LangPrimaryAbrev | Primary Language Code |
| LangSecondaryAbrev | Secondary Language Code |
| LangPrimaryID | Primary Language ID in the label files |
| LangSecondaryID | Secondary Language ID in the label files |
| PrintConfirmation | Prompts the user if second receipt printing is required |
| PrintOptCode | Print options |
| TrxOptCode | Transaction options |
| Taxes | Value of taxes application at retailers |
| BatchMax | The maximum number of allowed transactions prior to |
| | closing the batch with host |

Preferably, the menu display screen data is associated to a ‘Menu’ section 66 of the writable configuration file 60 and defines updatable configuration parameters related to a menu that appears on the display screen of the user interface. A menu is a list of options provided to the user via the user interface. For example, a menu may include a list of possible transactional operations. The menu display screen data may include parameters as exemplified in TABLE 2. Each item of a menu preferably corresponds to a “Menu ID” associating a label, a list of supported cards and a subsequent menu or transaction. The “Menu ID” may furthermore be associated to a password.

TABLE 2

| [MENU] | Description |
|---|---|
| Menu ID | Unlimited menus may be defined under this label. Each |
| | menu has its own ID |
| Label_id | Label associated with the Menu ID. Example, |
| | Menu ID M1 = Purchase |
| Password | If set, access to menu is protected by password. Each |
| | menu may have a password (0 = none) |
| Supported card | If empty, all card types have access to the menu. If |
| list | specified, only specified card types have access to the |
| | menu |
| Element of | M or T. M is a call to a menu, T is a call to transaction |
| menu | management |

Preferably, the password data is associated to a ‘Passwords’ section 68 of the writable configuration file 60 and defines updatable configuration parameters related to passwords that may be used to restrict access to certain functionalities of the terminal application. For example, a password may be required to restrict access for a reimbursement of an article to an authorized personnel of the merchant. Password data may include parameters as exemplified in TABLE 3.

TABLE 3

| [PASSWORDS] | Description |
|---|---|
| Password ID | Many passwords with different titles may be set |
| Password | The actual password associated with the Password title |

Preferably, the card type data is associated to a ‘BIN’ section 70 of the writable configuration file 60 and defines updatable configuration parameters related to the identification of supported account cards. A BIN (Bank Identification Number) is used to define the card type, for example VISA or MASTERCARD, and the issuing bank. Typically an account card is characterized by a 6-digits BIN number which may be followed by other digits to distinguish the card category. For example, an account card identified by a number beginning with 123456 may correspond to a VISA card, a card number identified by number 123456100 may correspond to a VISA GOLD card while a card identified by number 123456200 may correspond to a VISA PLATINUM card. The card type data may include parameters as exemplified in TABLE 4. Thus, according to a preferred embodiment of the present invention, card type data may be used to define a range of card types which are supported by the terminal application, by use of the parameters ‘BIN from’ and ‘BIN to’. The card type data may further comprise a ‘menu or TRX to call’ parameter for associating a menu or transaction which is prompted upon identification of a corresponding account card.

TABLE 4

| [BIN] | Description |
|---|---|
| Bin_ID | Many card BINs may be defined, each having its own ID |
| label_id | Label associated with the BIN. Example, BIN 123456 = |
| | Visa |
| Bin From | The starting number associated with the BIN |
| Bin To | The ending number associated with the BIN |
| Bin Size | The number of total digits in the card number |
| R? | |
| Menu or Trx to | Menu or transaction management called by the terminal |
| call | application when card is swiped |

Preferably, the card range data is associated to a ‘transactions_requests’ section 72 of the writable configuration file 60 and defines updatable configuration parameters related to a transactional operation which is applicable for a given account card. The card range data may include data such as a card list associated to an instance of a BIN_ID defined in the card type data, a password, a transaction associated to the card range data and a sequence of screens to be displayed via the user interface. The card range data may include parameters as exemplified in TABLE 5.

TABLE 5

| [transactions_requests] | Description |
|---|---|
| Transaction_ID | Transaction ID associated to the transaction. |
| | Unlimited transactions may be defined |
| transaction code | The code is associated with the transaction and |
| | recognized by the host |
| label_id | A label associated with the transaction |
| | (example = Purchase) |
| Password | If the transaction is protected by a password, |
| | the password ID is specified. If 0, then none |
| card list | Card list contains the BIN_IDs that can access |
| | the transaction_ID |
| screen(s) list | The sequence of screens to call to process the |
| | transaction |

Preferably, the display screen sequence data is associated to a ‘Screens’ section 74 of the writable configuration file 60 and defines updatable configuration file related to the sequence of screens displayed via the user interface during the operation of the dynamic configurable transaction system. Display screen sequence data may include parameters as exemplified in TABLE 6.

TABLE 6

| [screens] | Description |
|---|---|
| Screen_ID | The unique ID associated with the screen definition |
| Screen_type | Code defining the type of screen (see screen type |
| | definition for more detail) |
| Data Type | Code defining the data type gathered (see data type |
| | definition for more detail) |
| Label 1 (line 1) | Labels that are presented on the screen. Each label is |
| | associated with a line on the screen |
| Label 2 (line 2) | Labels that are presented on the screen. Each label is |
| | associated with a line on the screen |
| Label 3 (line 3) | Labels that are presented on the screen. Each label is |
| | associated with a line on the screen |
| Message_field | Specifies the message field name where the gathered |
| | information is stored |

Preferably, the ‘Screen_type’ parameter defines the type of screen displayed. The screen type data may define whether the screen allows a capture of data, a selection of preset keys from the terminal, a list of selections to select from, an entry of a numeric value, or whether the screen is editable and/or the like, as exemplified in TABLE 7.

TABLE 7

| [Screen_Type] | Description |
|---|---|
| E0 for field | The screen will allow the capture of data |
| E1 for function | The screen will allow a selection of preset key from the |
| key choice | terminal |
| E2 for list | The screen will allow a list of selections to select from |
| E3 mag stripe | The screen will allow the reading of cards |
| E4 for numeric | The screen will allow a numeric entry |
| key choice | |
| E5 for | The screen is not editable. Predefined value is shown. |
| constante | |
| E6 void | The screen will allow a void transaction to be processed |
| transaction | |

Preferably, the ‘Data_Type’ parameter defines the type of information that will be received by the payment terminal via the user interface. The ‘Data_Type’ parameter may define data types such as integer, date, time, alphanumeric, card number type and/or the like, such as exemplified in TABLE 8.

TABLE 8

| [Data_Type] | Description |
|---|---|
| D0 for integer | Data type integer |
| D1 for one decimal | Decimal value of one decimal |
| D2 for two decimals | Decimal value of two decimals |
| D3 for dollars | Decimal value with two decimals and the |
| | dollar sign on the screen |
| D4 for date | Date type value |
| D5 for time | Time type value |
| D6 for | Allow alphabetic and numeric information |
| alphanumeric | |
| D7 pan | Card number type |
| D8 for choice of key | Allow selection of integer value in the form |
| choice | of a choice |
| D9 original | Allow transaction number data type |
| transaction | |
| information | |
| D10 for constant | Predefined value (not editable) |

Preferably, values for ‘Screen_type’ and ‘Data_Type’ parameters are defined in the terminal application. Alternatively these values may be defined in the writable configuration file 60 or in another data object, as apparent to a person skilled in the art.

Preferably, the hardware specification data is associated to a ‘mask_format equipment’ section 80 of the writable configuration file 60 and defines updatable configuration parameters related to the manufacturer or model of the transaction terminal. Transaction terminals preferably have different hardware specification for display screen layout for receiving input information depending on the manufacturer or model. Hardware specification data may define the maximum and minimum number of characters that may appear on the display screen for a particular manufacturer or model of transaction terminal. Hardware specification data may include parameters as exemplified in TABLE 9.

TABLE 9

| [mask_format_equipment] | Description |
|---|---|
| Funtion_ID | Defines the function key ID of specific |
| | terminal manufacturer (manufacturers |
| | have different numbers of functions) |
| minKeys | Minimum data input length |
| maxKeys | Maximum data input length |
| defautl value | Default data input value string |
| mask | Data entry mask string |

Preferably, the network data is defined in a ‘Network’ section 82 of the writable configuration file and defines the communication hierarchy used by the terminal application to establish a communication with the central server via the system network. Network data may include parameters as exemplified in TABLE 10.

TABLE 10

| [Network] | Description |
|---|---|
| Primary | Defines the primary network type (example = Ethernet). |
| | The field name relates to the configuration section |
| Secondary | Defines the secondary network type (example = Dial |
| | up). The field name relates to the configuration section |

Preferably, the network data is further defined in a ‘Ethernet1’ section 84 or ‘Dialup’ section 86 of the writable configuration file 60, which preferably corresponds to a ‘Primary’ or ‘Secondary’ parameter of the ‘Network’ section 82. According to a preferred embodiment of the present invention, a total of two network configurations may be defined. Data comprised in the ‘Ethernet1’ section 84 may include parameters as exemplified in TABLE 11.

TABLE 11

| [Ethernet1] | Description |
|---|---|
| DatalinkType | Defines the communication type (example = |
| | Ethernet) as defined by the manufacturer |
| DHCP | Configures the how the terminal application 32 |
| | gets its IP address (DHCP = Y or N) |
| SecurityMethod | If defined, it will use SSL certification |
| Terminal | If not DHCP, this defines the terminal IP address |
| Gateway | If not DHCP, this defines the gateway |
| Netmask | If not DHCP, this defines the Netmask |
| Host | Defines the host IP address |
| Port | Defines the host Port number |
| ConnectTimeout | Defines the wait type prior to establishing a |
| | connection |
| SendRecvTimeout=30 | Defines the wait type for a transaction to be |
| | sent and received from the host |

Preferably, the security data is associated to a ‘Security’ section 88 of the writable configuration file 60 and defines whether security is required in communications between the transaction terminal and the central server. Security data may include a parameter as exemplified in TABLE 12.

TABLE 12

| [Security] | Description |
|---|---|
| Mandatory | If Y and SSL are not used, all transactions are |
| | encrypted |

Referring to FIG. 4, the writable label file 62 preferably contains a list of labels 90 which are textual expressions available to the terminal application 32 for providing output information on the user interface 30. The labels 90 may be used for displaying a message on the display screen 50 of the terminal application 32, the display screen 50 of the pinpad 56, on a receipt, etc (see FIGS. 2a to 2d). Such labels 90 are generally limited to expressions typically used in a transaction system and require few changes during operation of a transaction system. Therefore, the information related to such labels 90 may be maintained in the writable label file 62, independently of the writable configuration file 60. The writable label file 62 is preferably updatable as can be easily understood by a person skilled in the art.

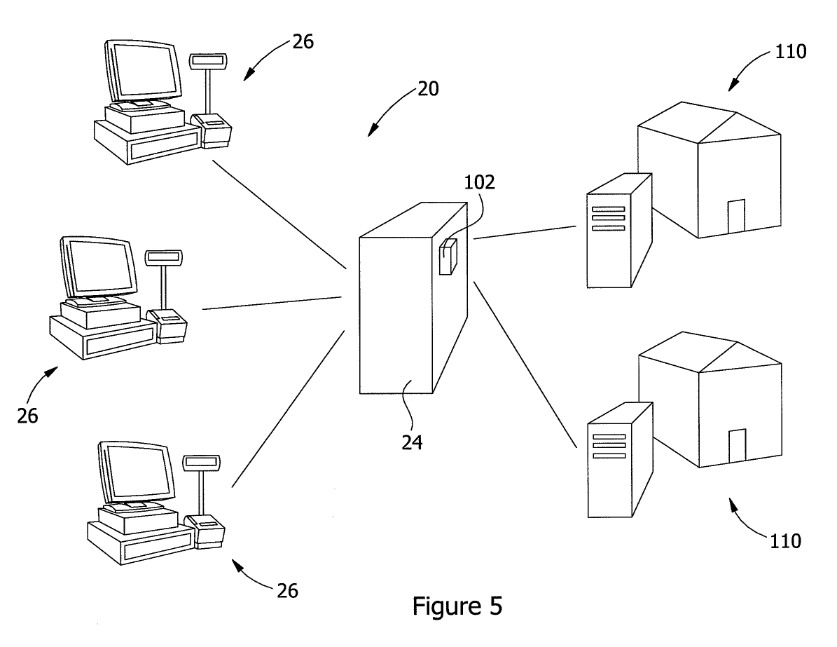

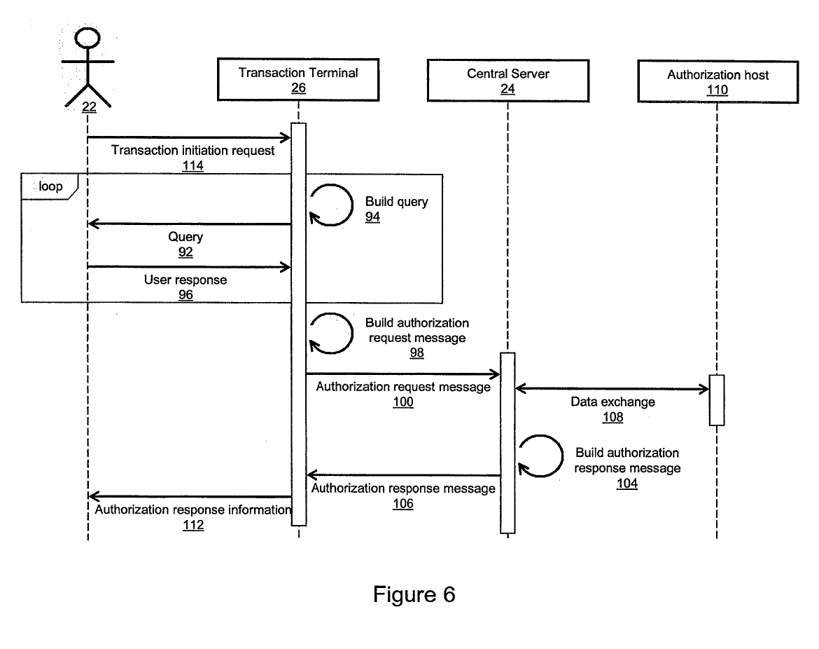

Referring namely to FIGS. 5 and 6, and further referring to FIGS. 1 and 4, the output information preferably includes at least one query 92 to the user 22, each query 92 being composed of labels 90 from the writable label file 62, the transaction module 36 building 94 each query based on data from the writable configuration file 60. The input information preferably includes a user response 96 to each of the queries 92, and the transaction flow consists in presenting each query 92 to the user 22, receiving the user response 96 to each query 92 and building an authorization request message 98 incorporating the user responses 96. The central server 24 preferably includes an authorization module 102 for receiving the authorization request message 100 from the transaction terminal 26, building an authorization response message 104 in response to the authorization request message 100 and transmitting the authorization response message 106 to the transaction terminal 26. The authorization module 102 of the central server 24 preferably builds the authorization response message 106 based on a data exchange 108 with an authorization host 110. According to a preferred embodiment of the present invention, the central server 24 acts as an interface between one or more transaction terminals 26 and one or more authorization hosts 110, as illustrated in FIG. 5 of the drawings. An authorization host 110 may be a bank, a loyalty point card supplier, and/or any institution which authorizes a transactional operation. Alternatively, the central server 24 may be integrated with the authorization host system 110.

With regards to the operational aspect of the dynamic configurable transaction system 20 according to a preferred embodiment of the present invention and as exemplified in FIG. 6 and further referring to FIGS. 1, 2 and 5, an operational transaction is preferably initiated when the transaction terminal 26 receives a transaction initiation request 114. The terminal application 32 is then triggered to build at least one query 94. A query 92 may be built based on input information from the user 22, for example card information or a user selection based on a menu. The query may further be built 94 based on the transaction flow which is defined by updatable configuration parameters 34, input information received from the user 22 and information required by the authorization host 110. The query 92 is transmitted to the user 22 via the user interface 30, preferably in the form of a message displayed on the display screen 50, for example a menu of options, a question, an information request, etc., requesting the user 22 to provide a user response 96. The user response 96 may include for example an amount entered via the keypad 46, a user selection from a menu, a swiping of the card in the card reader 48, a password entered via the keypad 46, etc. According to a preferred embodiment of the present invention an exchange of queries 92 and user responses 96 takes place between the transaction terminal 26 and the user 22. Based on the user responses 96, the terminal application 32 builds an authorization request message 100 which is transmitted to the central server 24. The authorization module 102 of the central server 24 receives the authorization request message 100 from the transaction terminal 26, and preferably reformats the authorization request message 100 such that it is compatible with the corresponding authorization host 110 to which the authorization request message 100 is destined, as known in the art. Preferably, the authorization host 110 receives the data via the authorization module 102 of the central server 24, processes the transactional operation and provides a response to the central server 24. A data exchange 108 may take place between the central server 24 and the authorization host 110 so as to allow the authorization module 102 of the central server 24 to build an authorization response message 106 based on data received from the authorization host 110 in a format which is compatible with the transaction terminal 26. The central server 24 transmits the authorization response message 106 to the transaction terminal 26 which in turn provides authorization response information 112 to the user 22 via the user interface 30. The authorization response information 112 is based on the authorization response message 106 and may include a confirmation of the completion of the transactional operation, a refusal of the transactional operation, a personalized message for the user, a receipt printed via the printer 52, and/or any other relevant information related to the transactional operation and/or user account. More than one authorization hosts 110 may interact with the central server 24 for a single transactional operation as can be easily understood by a person skilled in the art. For example, a transactional operation may consist of a payment via a credit card which is linked to a loyalty points program, in which case a data exchange 108 takes place between the central server 24 and the corresponding bank as well as between the central server 24 and the corresponding loyalty points provider, and the authorization response message 106 may include information related to all concerned authorization hosts 110.

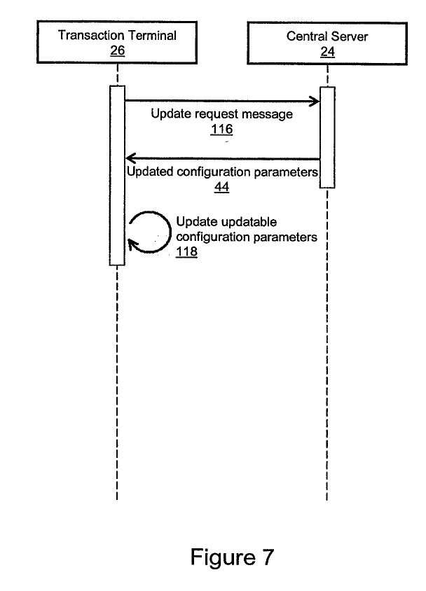

Referring namely to FIG. 7 and further referring to FIGS. 1 and 3, the terminal application 32 of the dynamic configurable transaction system 20 allows for an update of the updatable configuration parameters 34 preferably by sending an update request message 116 to the central server 24, receiving the updated configuration parameters 44 from the central server 24, and updating 118 the updatable configuration parameters 34 based on the updated configuration parameters 44 received from the central server 24. The update request message 116 is preferably generated based on an update schedule. For example, a bank may choose to apply a modification requiring an update of the updatable configuration parameters 34 provided with a time and date at which the modification will be effective. This modification may be entered in the configuration update module 42 of the central server 24, which will provide the scheduled period information to the terminal application 32 when activities are initiated from the terminal application 32 with the central server 24. At this specific scheduled date, the terminal application 32 will communicate with the central server 24 to load the updated files and thus update the updatable configuration parameters 34. The update schedule preferably corresponds to a time window when the transaction terminal 26 is less likely to be used, so as to avoid interference with the operation of the transaction system. Alternatively, the update 118 of the updatable configuration parameters 34 may be prompted by an update request message 116 generated by the terminal application 32 and sent to the central server 24. The update request message 116 may also be automatically generated upon activity at the transaction terminal 26, for example upon an initiation or a completion of a transactional operation. The update request message 116 may alternatively be generated by an update initiation functionality comprised in the terminal application 32 and prompted by the user 22 of the transaction terminal 26. Alternatively, the update request message 116 may be generated periodically by the terminal application 32, or by the server application 40.

The updated configuration parameters 44 is transmitted from the central server 24 to the terminal application 32 via the system network 28. The updated configuration parameters 44 may be transferred, for example, in the form of a file. The updated configuration parameters 44 may be transferred via a secure file transfer protocol such as Secure Shell (SSH), Secure Sockets Layer (SSL) and/or the like. Upon receiving the updated configuration parameters 44 from the central server 24, the terminal application 32 preferably decodes the updated configuration parameters 44 if required, and replaces the updatable configuration parameters 34, by the updated configuration parameters 44 received from the central server 24.

According to a preferred embodiment of the present invention, the updated configuration parameters 44 may be used to update the writable configuration file 60 and/or the writable label file 62, as apparent to a person skilled in the art.

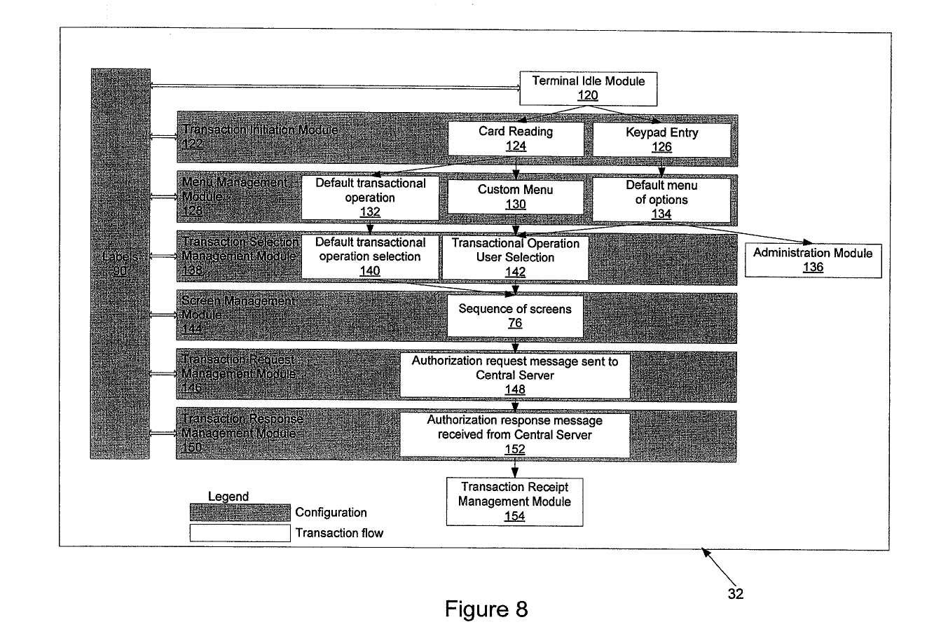

Referring namely to FIG. 8 and further referring to FIGS. 1, 2 and 6, the operational aspect of the terminal application 32 according to one embodiment of the invention is represented by a flowchart. It will be understood by one skilled in the art that the configuration illustrated by FIG. 8 is given simply by way of example and that the present invention could alternatively be embodied by a multitude of different arrangements of modules and sub-modules. The terminal application 32 preferably includes a terminal idle module 120 for waiting to receive a transaction initiation request 114. The terminal idle module 120 corresponds to an inactive state of the terminal application 32 while waiting for a transactional operation to be initiated.

Preferably, the terminal application 32 includes a transaction initiation module 122 for initiating a transactional operation upon reception of the transaction initiation request 114 via the user interface 30. The transaction initiation module 122 corresponds to the initiation of a transactional operation by a user 22. The transaction initiation request 114 is preferably generated by a card reading 124, for example by swiping an account card in the card reader 48 or by a keypad entry 126, for example by pressing one or more keys of the keypad 46. Alternatively, the terminal application may be adapted to receive any other action performed via the user interface 30 to initiate a transactional operation, as apparent to a person skilled in the art.

Preferably, the terminal application 32 further includes a menu management module 128 for dynamically building a menu of options based on the input information and providing the menu of options via the user interface 30, the menu management module 128 being prompted by the transaction initiation module 122. Thus, the transaction initiation module 122 prompts the menu management module 128 to present a menu of options, for example a list of one or more transactional operations, and/or a list of one or more functional operations via the user interface 30. The items displayed as part of the menu of options are based on the input information received by the transaction initiation module 122, for example account information and/or a user selection via the keypad 46. Preferably, if the transactional operation is initiated by a card reading 124, a custom menu of transactional operations 130 applicable to the corresponding account is displayed on the display screen 50. Alternatively, upon reading the account information, a default transactional operation 132 may apply. If the transactional operation is initiated by a keypad entry 126, a default menu of options 134 is preferably presented on the display screen 50.

Preferably, the terminal application 32 further includes an administration module 136 for receiving an administrative operation selection via the user interface 30 and completing a corresponding administrative operation on the transaction terminal 26, the administration module 136 being prompted by the menu management module 128. An administrative operation may include end-of-day operations and the like, and is preferably prompted upon entry of a user selection from the default menu of options 134 presented by the menu management module 128 upon initiation of a transactional operation by a keypad entry 126.

Preferably, the terminal application 32 includes a transaction selection management module 138 for receiving a transactional operation selection via the user interface 30, the transaction selection management module 138 being prompted by the menu management module 128. If a transactional operation is selected from a custom menu of transactional operations 130 applicable to an account or from a default menu of options 134 comprising transactional operations, the transaction selection management module 138 receives the transactional operation user selection 142. Alternatively, if the default transactional operation 132 applies, the transaction selection management module 138 receives a corresponding default transactional operation selection 140.

Preferably, the terminal application 32 further comprises a screen management module 144 for dynamically building a sequence of input and output screens 76 via the user interface 30, the sequence being determined by the transactional operation selection, the input information received via the user interface 30 and the writable configuration file 60, illustrated in FIG. 3, the screen management module 144 being prompted by the transaction selection management module 138. The screen management module 144 preferably initiates a transaction flow which is dynamically built based on the input information and the updatable configuration parameters 34. The transaction flow may include an exchange of input and output information with the user 22 via the user interface 30, for collecting information required to process the transactional operation.

Preferably, the terminal application 32 further includes a transaction request management module 146 for dynamically building an authorization request message 100 based on the input information related to the transactional operation and on the writable configuration file 60, and transmitting the authorization request message 148 to the central server 24 for completing the transactional operation, the transaction request management module 146 being prompted by the screen management module 144. Preferably, the transaction request management module 146 is prompted when the exchange of information with the user 22 is completed and all the information required to process the transactional operation is gathered. The transaction request message is transmitted to the central server 24, preferably via the system network 28. The authorization request message 100 may be transmitted by a secure file transfer protocol such as SSH, SSL, or other data transfer protocols, and may be encrypted for security purposes. Generally the authorization request message 100 is received by the central server 24, translated and sent to an authorization host 110 for processing and completing the transactional operation with the corresponding account. The authorization host 110 then generates an authorization response message 106 which is received by the central server 24, translated and transferred to the transaction terminal 26.

Preferably, the terminal application 32 further includes a transaction response management module 150 for receiving the authorization response message 152 from the central server 24 and transmitting authorization response information 112 to the user 22 via the user interface 30. The authorization response information 112 may include output information such as confirmation of the completion of the transactional operation, indication of a refusal of the transactional operation, a personalized message for the user and/or any other data related to the transactional operation and/or corresponding account.

Preferably, the terminal application 32 further comprises a transaction receipt management module 154 for providing a receipt of the transactional operation via the user interface 30, the receipt being preferably formatted based on the authorization response message 106 received from the central server 24, the transaction receipt management module 154 being prompted by the transaction response management module 150. Alternatively, the format of the printed receipt may be based on the updatable configuration parameters 34 of the terminal application 32, or on the authorization response message 106 in combination with the updatable configuration parameters 34. Thus, the receipt may be personalized based on the user, the merchant, the updatable configuration file of the transaction terminal, the authorization host and/or the particular transactional operation. Moreover, the format of the receipt includes any data appearing on a receipt, such as printed text, an image, a bar code, a receipt layout and/or the like. For example, a personalized message may appear on the receipt.

Preferably, each of the above-described modules cooperates with the writable label file 62 for presenting textual information to the user 22 by use of labels 90, as illustrated in FIG. 4. Of course, the above-described example including modules and operational step may be altered without departing from the essential elements of the present invention, as can be easily understood by a person skilled in the art.

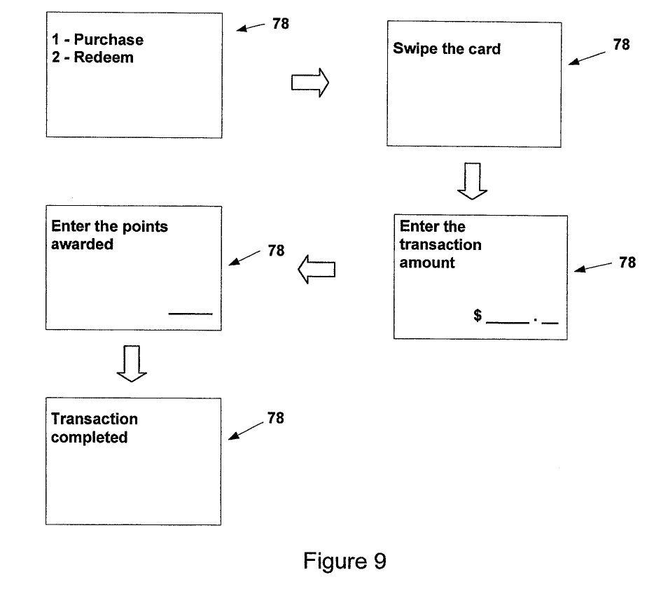

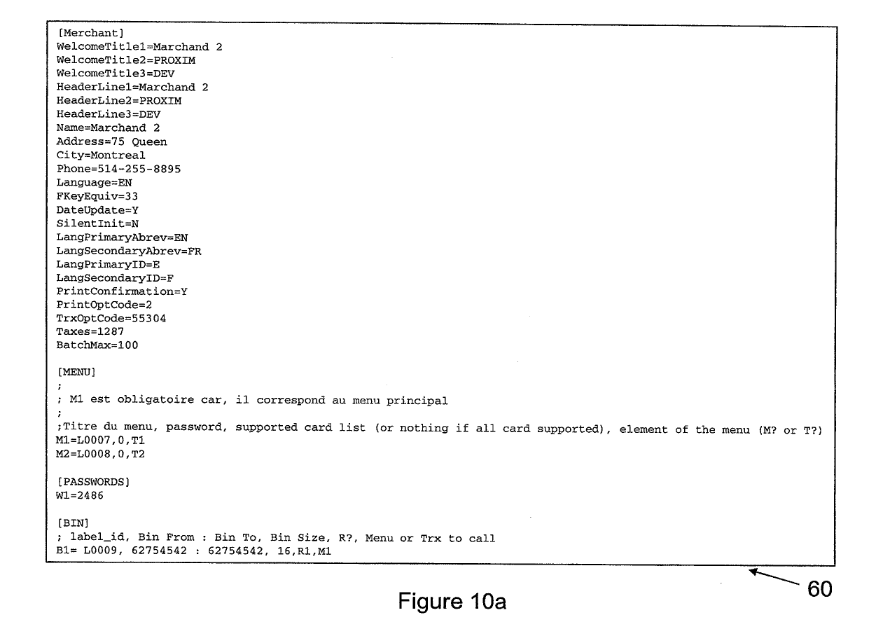

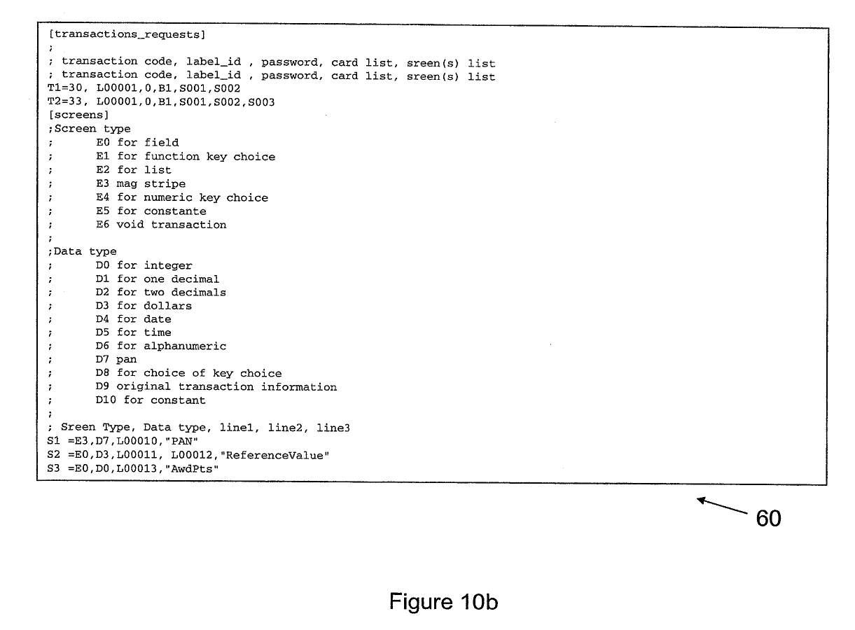

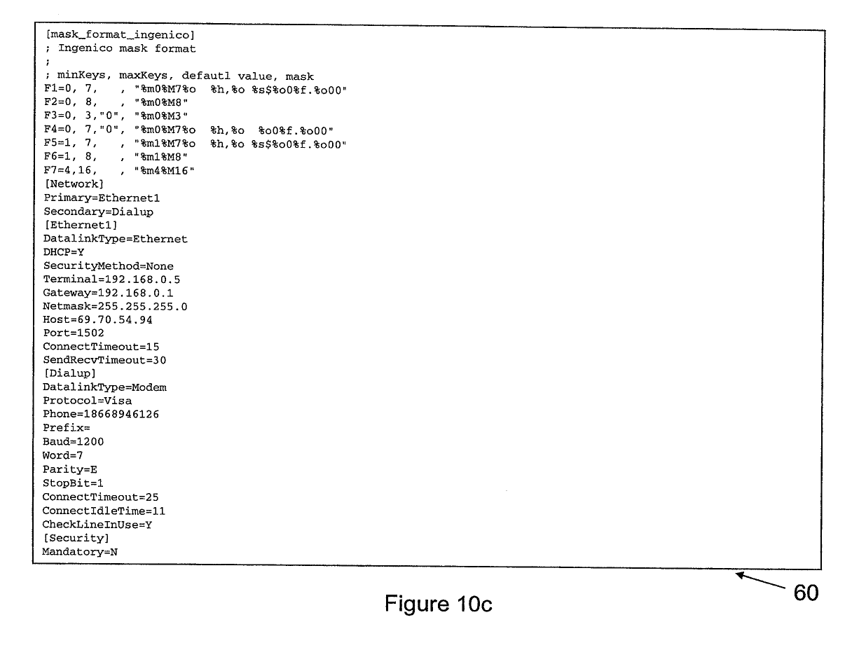

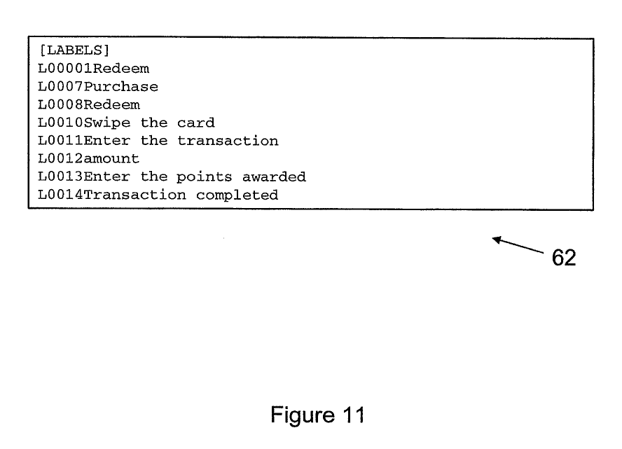

Referring namely to FIGS. 9 to 11 and further referring to FIGS. 1, 2, 3, 4, 6 and 8, a transaction flow according to a preferred embodiment of the present invention is exemplified based on the sections of the writable configuration file 60 as defined in TABLES 1 to 12. FIG. 9 illustrates a sequence of screens 78 that may be presented via a display screen 50. FIGS. 10a to 10c illustrate the corresponding writable configuration file 60. FIG. 11 illustrates the corresponding writable label file 62.

The first screen displays a menu of options presenting two transactional operations: “purchase” and “redeem”. The menu of options displayed is based on the ‘Menu’ section 66 of the writable configuration file 60. The parameters “L0007” and “L0008” refer to labels 90 found in the writable label file 62.

According to this example, the user 22 selects the “redeem” item of the menu, corresponding to the transaction management module of the terminal application 32. The element “M2” of the menu requires no password and prompts transaction ID “T2”. The transaction flow associated to transaction ID “T2” is applicable to the card numbers defined at “B1” of the ‘BIN’ section 70 of the writable configuration file 60. This information will be validated when the card is swiped within the transaction flow of the screen management module 144. The transaction flow corresponding to transaction ID “T2” includes screens corresponding to screen ID “S001”, “S002” and “S003” based on the writable configuration file 60, screen ID “S001” is associated to a screen type “E3” which corresponds to a “magnetic screen” defining an input screen for a card reading 124. The data type expected in this screen is of type “D7”, which corresponds to a PAN (primary account number) or card number. The screen “S001” is further associated to label ID “L0010”, which causes the expression “swipe the card” to be displayed on line 1 of the display screen 50. The input information which will be entered by the user 22 will be stored in the PAN field of the authorization request message 100.

Once the card is swiped, the screen 78 corresponding to screen ID “S002” displays the expression “enter the transaction amount” on lines 1 and 2 of the display screen 50 based on labels “L0011” and “L0012” of the writable label file 62. The screen type corresponding to “S002” is E0, allowing the user 22 to enter data of data type D3, corresponding to dollar type data. The value received via this screen 78 will be stored in the ‘reference value’ field of the authorization request message 100.

Once the input data is entered in response to the ‘S002’ screen, the ‘S003’ screen is prompted and displays the expression “enter the points awarded” based on label “L0013” of the writable label file 62. The ‘S003’ screen type allows a data field of type integer to be gathered. The user response 96 message will be stored in the “AwsPts” field of the authorization request message 100.

The terminal application 32 then builds the authorization request message 100 based on the input information received from the user 22 and sends the authorization request message 100 to the central server 24 via the system network 28. Upon reception of the authorization response message 106 from the central server 24, the terminal application 32 displays a screen 78 corresponding to the confirmation of the transactional operation, by use of the label “L0014” indicating to the user 22 that the transaction was successfully.

Embodiments of the present invention are particularly advantageous in that the above-described dynamic configurable transaction system allows for configuration parameters such as data related to the merchant, data related to the user interface, data related to an authorization host, etc. to be easily updated at the transaction terminal without requiring a change, upgrade or replacement at the software level, which generally results in a lengthy, costly and elaborate process. The above-described dynamic configurable transaction system further avoids the need for a technician to be present on site for modifying the transaction terminal. Moreover, the risk of malfunction due to a programming error, incompatibility with a specific model of device, etc., is considerably reduced.

Embodiments of the present invention provide numerous advantages over the prior art in that the dynamic configurable transaction system bridges the gap between transaction terminals of different manufacturers. Indeed, the updatable configuration parameters may be updated independently of the terminal application which may vary from one transaction terminal to another depending on the manufacturer or model. Moreover, the updatable configuration parameters being maintained centrally in the central server, is easily managed and maintained. Furthermore, the operation of the terminal transaction is customized to the user. The sequence of screens is dynamically built based on input information such as card number and user selection as well as on the updatable configuration parameters, rendering the transaction system to operate in a flexible and customized manner.

Several modifications could be made to the above-described dynamic configurable transaction system, without departing from the scope of the present invention, as can be easily understood by a person skilled in the art. For example, the writable configuration file may define data according to other data structures. Furthermore, the updatable configuration parameters may be organized in the form of a database and/or maintained in several files or other data objects. Moreover, the exchange of input and output information between the user and the terminal application, for example of queries and user responses, may be completed via a speaker and a microphone, a touch screen, etc. Moreover, the server application may be comprised in a network of servers, such as a distributed system, for performance and security purposes.

Several other modifications could be made to the above-described dynamic configurable transaction system. Indeed, some components of the system may be organized in alternate ways without departing from the scope of the present invention. For example, a portion of the updatable configuration parameters may be located at the central server, such that the terminal application operates by interacting with the central server. Alternately, the updatable configuration parameters may be located in a server which is distinct of the server which houses the server application. Moreover, the central server or the authorization module thereof may be located at the authorization host, as can be easily understood by a person skilled in the art.

Of course, numerous other modifications could be made to the above-described and exemplified embodiments without departing from the scope of the invention. The above-described embodiments are considered in all respects only as illustrative and not restrictive, and the present application is intended to cover any adaptations or variations thereof, as apparent to a person skilled in the art.

1. A dynamic configurable transaction system enabling a user to complete a transactional operation through a central server, the system comprising:
a transaction terminal in communication with the central server via a system network, comprising:
a user interface allowing to exchange input and output information related to the transactional operation with the user; and
a terminal application in communication with the user interface, the terminal application comprising updatable configuration parameters and a transaction module for dynamically building a transaction flow related to the transactional operation based on the input information received via the user interface and on the updatable configuration parameters; and
a server application at said central server comprising a configuration update module for preparing updated configuration parameters and transmitting said updated configuration parameters to the transaction terminal.

2. The dynamic configurable transaction system according to claim 1, wherein the input information comprises card information from a transaction card associated with said user.

3. The dynamic configurable transaction system according to claim 1, wherein the user interface of the transaction terminal comprises at least one of a card reader and a keypad for inputting said input information.

4. The dynamic configurable transaction system of claim 1, wherein the user interface of the transaction terminal comprises at least one of a display screen, a printer and a speaker for outputting the output information.

5. The dynamic configurable transaction system of claim 1, wherein the user interface of the transaction terminal comprises a pinpad.

6. The dynamic configurable transaction system of claim 1, wherein the updatable configuration parameters are contained in a writable configuration file and a writable label file.

7. The dynamic configurable transaction system of claim 6, wherein the writable configuration file comprises merchant personalization data, menu display screen data, password data, card type data, card range data, display screen sequence data, screen type data, date type data, hardware specification data, network data and security data.

8. The dynamic configurable transaction system according to claim 6, wherein the output information comprises at least one query to the user, each of said at least one query being composed of labels from said writable label file, the transaction module building each of said at least one query based on instructions from the writable configuration file.

9. The dynamic configurable transaction system according to claim 8, wherein the input information comprises a user response to each of the at least one query, and the transaction flow comprises:
presenting each of the at least one query to the user;
receiving the user response to each of said at least one query; and
building an authorization request message incorporating said user responses.

10. The dynamic configurable transaction system according to claim 9, comprising an authorization module at said central server for receiving the authorization request message from the transaction terminal, building an authorization response message in response to said authorization request message and transmitting the authorization response message to the transaction terminal.

11. The dynamic configurable transaction system according to claim 10, wherein the authorization module builds said authorization response message based on a data exchange with at least one authorization host.

12. The dynamic configurable transaction system of claim 1, wherein the terminal application allows for an update of the updatable configuration parameters by:
(a) receiving the updated configuration parameters from the central server; and
(b) updating the updatable configuration parameters based on the updated configuration parameters received from the central server.

13. The dynamic configurable transaction system of claim 12, wherein the terminal application comprises an update initiation functionality for generating and sending an update request message to the central server.

14. The dynamic configurable transaction system of claim 13, wherein the update request message is generated based on an update schedule.

15. The dynamic configurable transaction system of claim 13, wherein the update request message is automatically generated upon either one of an initiation or a completion of said transactional operation by the user.

16. The dynamic configurable transaction system of claim 13, wherein the update request message is generated periodically by the terminal application.

17. A terminal application provided in a transaction terminal of a dynamic configurable transaction system, the transaction terminal being in communication with a central server via a system network and enabling a user to complete a transactional operation, the transaction terminal comprising a user interface allowing to exchange input and output information related to the transactional operation with the user, the terminal application comprising:
updatable configuration parameters;
an update module for receiving updated configuration parameters from the central server and replacing the updatable configuration parameters therewith; and
a transaction module for dynamically building a transaction flow related to the transactional operation based on the input information received via the user interface and on the updatable configuration parameters.

18. The terminal application according to claim 17, wherein the updatable configuration parameters is contained in a writable configuration file and a writable label file.

19. The terminal application according to claim 18, wherein the writable configuration file comprises merchant personalization data, menu display screen data, password data, card type data, card range data, display screen sequence data, screen type data, date type data, hardware specification data, network data and security data.

20. The terminal application according to claim 17, wherein the terminal application comprises:
a terminal idle module for waiting to receive a transaction initiation request,
a transaction initiation module for initiating a transaction upon reception of a transaction initiation request via the user interface,
a menu management module for dynamically building a menu of options based on the input information and providing the said menu via the user interface, the menu management module being prompted by the transaction initiation module,
an administration module for receiving an administrative operation selection via the user interface and completing a corresponding administrative operation on the transaction terminal, the administration module being prompted by the menu management module,
a transaction selection management module for receiving a transaction selection via the user interface, the transaction selection management module being prompted by the menu management module,
a screen management module for dynamically building a sequence of input and output screens via the user interface, said sequence being determined by the transactional operation selection, the input information received via the user interface and the writable configuration file, the screen management module being prompted by the transaction selection management module,
a transaction request management module for dynamically building an authorization request message based on the input information related to the transactional operation and on the writable configuration file, and transmitting the said authorization request message to the central server for completing the transactional operation, the transaction request management module being prompted by the screen management module,
a transaction response management module for receiving an authorization response message from the central server and providing authorization response information via the user interface, based on the authorization response message,
a transaction receipt management module for providing a receipt of the transactional operation via the user interface, the receipt being formatted based on the authorization response message received from the central server, the transaction receipt management module being prompted by the transaction response management module.

21. The terminal application according to claim 20, wherein transaction receipt management module provides personalized data on the receipt.

22. The terminal application according to claim 21, wherein the personalized data provided on the receipt comprises a personalized message to the user.

23. A method for dynamically configuring a transaction system enabling a user to complete a transactional operation through a central server, the method comprising:
a) providing a transaction terminal at a terminal in communication with the central server via a system network, comprising a user interface allowing to exchange input and output information related to the transactional operation with the user, and a terminal application in communication with the user interface, the terminal application comprising updatable configuration parameters and a transaction module for dynamically building a transaction flow related to the transactional operation based on the input information received via the user interface and on the updatable configuration parameters;
b) preparing updated configuration parameters at said central server;
c) transmitting said updated configuration parameters to the transaction terminal; and
d) updating the updatable configuration parameters based on the updated configuration parameters received from the central server.

24. The method of claim 23, comprising, before transmitting of c) generating an update request message at said terminal and sending said update request message to the central server.

25. The method of claim 24, wherein the update request message is generated based on an update schedule.

26. The method of claim 24, wherein the update request message is automatically generated upon either one of an initiation or a completion of said transactional operation by the user.

27. The method of claim 24, wherein the update request message is generated periodically by the terminal application.
